(19) United States
(12) Patent Application Publication
(10) Pub. No.: US 2009/0224616 A1
(43) Pub. Date: Sep. 10, 2009

(54) Flat Vibration Motor

(76) Inventor: Sung Hwan An, Gwangjoo-shi (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 11/720,233

(22) PCT Filed: Feb. 3, 2006
(86) PCT No.: PCT/KR2006/000395

§ 371 Date: May 25, 2007

(30) Foreign Application Priority Data
Feb. 5, 2005 (KR) 10 2005 0011029

(51) Int. Cl. H02K 7/075; H02K 5/04

(52) U.S. Cl. 310/81; 310/91

(57) ABSTRACT

A flat vibration motor with a structure for coupling a stator portion and a base portion thereof is provided. The flat vibration motor includes a rotor portion, a stator portion, a fixing mount, and a base portion. The rotor portion generates vibrating force when rotating. The stator portion houses and couples with the rotor portion to allow the rotor portion to rotate. The fixing mount extends from the stator portion and includes a plurality of fixing arms formed to extend upward therefrom. The base portion includes a terminal for supplying electricity to the stator portion, and a plurality of fixing grooves formed thereon for respectively coupling with the fixing arms. The structure prevents a disruption of an electrical connection between a terminal and a control circuit board caused by a shift or disengagement in a coupling between the base portion and the stator portion.

### TECHNICAL FIELD

The present invention relates to a vibration motor, and more particularly, a flat vibration motor.

### BACKGROUND ART

A flat vibration motor is a miniature motor that can be installed in cellular phones, smart phones, personal digital assistants (PDA), and similar mobile telecommunication terminals and various other electronic devices. When a signal is received from a call center, a flat vibration motor can alert a user of an incoming call through vibrations instead of sound.

More specifically, when set in “manner mode”, a mobile telecommunication terminal transmits vibrations through the operating of such a flat vibration motor.

A flat vibration motor is coin-sized and generates a strong vibrating force, so that it requires a relatively durable coupling structure. However, its terminals are often deformed due to the strong vibrating force, so that the coupling of the stator portion and the base portion develops problems.

FIG. 1 is a perspective view of a flat vibration motor according to the related art.

Referring to FIG. 1, a flat vibration motor according to the related art includes a stator portion 10, a rotor portion (inside the stator portion), and a base portion 20.

The stator portion 10 forms a housing within which the rotor portion is rotatably disposed, so that vibrating force imparted by the rotor portion can be transmitted to the outside. Also, the stator portion 10 has a circuit board (not shown) for transmitting electricity to the rotor portion, and allows the rotor portion to rotate.

The base portion 20 has a terminal 22 through which electricity is transmitted from an external source, and is coupled to the stator portion 10. The terminal 22 is connected to the circuit board of the stator portion 10.

Here, the base portion 20 and the stator portion 10 are coupled with an adhesive 30; however, such a coupling using the adhesive 30 reduces the service life of the vibration motor.

Specifically, depending on the hardened degree of the adhesive 30 or the external environmental conditions (such as a shock from a user dropping the mobile telecommunication terminal), the coupled surfaces of the stator portion 10 and the base portion 20 may develop a gap or completely disengage from each other.

When such a problem of coupling the stator portion 10 and the base portion 20 occurs, it can induce a problem in the connection between the terminal 22 and the circuit board, and disrupt the supply of electricity.

### DISCLOSURE OF INVENTION

### Technical Problem

To solve these problems, the present invention provides an improved coupling structure of a flat vibration motor capable of preventing operating failure or irregular operation of the motor as a result of shock incurred thereto.

Furthermore, the flat vibration motor according to the present invention uses a physical structure to more firmly couple its stator and base portions, in conjunction with the existing adhesive coupling.

### Technical Solution

To achieve the above objects, there is provided a flat vibration motor including: a rotor portion for generating vibrating force when rotating; a stator portion housing and coupled with the rotor portion to allow the rotor portion to rotate, the stator portion for transmitting electricity; a fixing mount extending from a side of a lower case of the stator portion and including a plurality of fixing arms formed to extend upward therefrom; and a base portion including a terminal for supplying electricity to the stator portion, and a plurality of fixing grooves formed thereon for respectively coupling with the fixing arms.

According to another aspect of the present invention, there is provided a flat vibration motor including: a rotor portion for generating vibrating force when rotating; a stator portion housing and coupled with the rotor portion to allow the rotor portion to rotate, the stator portion for transmitting electricity; a fixing mount extending from a side of a lower case of the stator portion and including a plurality of fixing arms formed to extend upward therefrom; and a base portion including a terminal for supplying electricity to the stator portion, and a plurality of fixing grooves formed thereon for respectively coupling with the fixing arms, wherein at least one fixing groove has an angled surface, and a fixing arm that inserts in the fixing groove is altered in shape to press against the angled surface, for coupling the stator portion with the base portion.

According to a further aspect of the present invention, there is provided a flat vibration motor including: a rotor portion for generating vibrating force when rotating; a stator portion housing and coupled with the rotor portion to allow the rotor portion to rotate, the stator portion for transmitting electricity; a fixing mount extending from a side of a lower case of the stator portion and including a plurality of fixing arms formed to extend upward therefrom; and a base portion including a terminal for supplying electricity to the stator portion, and a plurality of fixing grooves formed thereon for respectively coupling with the fixing arms, wherein the fixing arms support the base portion in at least two directions.

### ADVANTAGEOUS EFFECTS

An advantage of the flat vibration motor according to the present invention is that it prevents a change in or disengagement of the coupling of the base portion and the stator portion, so that a disruption in the electrical connection between the terminal and the control circuit board can be obviated.

Also, the flat vibration motor according to the present invention uses a physical structure to couple the stator portion and the base portion, so that the manufacturing process is more efficient.

Furthermore, the flat vibration motor according to the present invention uses a curved elastic portion of the terminal and a coupling of the base portion and stator portion, so that a wide range of shock levels incurred can be absorbed.

### BRIEF DESCRIPTION OF THE DRAWINGS

The spirit of the present invention can be understood more fully with reference to the accompanying drawings. In the drawings:

FIG. 1 is a perspective view of a flat vibration motor according to the related art;

FIG. 2 is a schematic sectional side view showing the interior configuration of a flat vibration motor according to an embodiment of the present invention;

FIG. 3 is perspective view showing a coupling structure of a base portion and a stator portion of a flat vibration motor according to the first embodiment of the present invention;

FIG. 4 is a perspective view showing the base portion assembled with the stator portion of the flat vibration motor in FIG. 3;

FIG. 5 is a perspective view showing a coupling structure of a base portion and a stator portion of a flat vibration motor according to the second embodiment of the present invention;

FIG. 6 is a perspective view showing the base portion assembled with the stator portion of the flat vibration motor in FIG. 5;

FIG. 7 is a side view showing the base portion assembled with the stator potion of the flat vibration motor in FIG. 5;

FIG. 8 is a perspective view of a base portion of a flat vibration motor according to the third embodiment of the present invention;

FIG. 9 is a perspective view showing a base portion coupled with a stator portion of a flat vibration motor according to the third embodiment of the present invention;

FIG. 10 is perspective view showing a coupling structure of the base portion and the stator portion of the flat vibration motor according to the fourth embodiment of the present invention; and

FIG. 11 is a perspective view showing the base portion coupled with the stator portion of the flat vibration motor in FIG. 10.

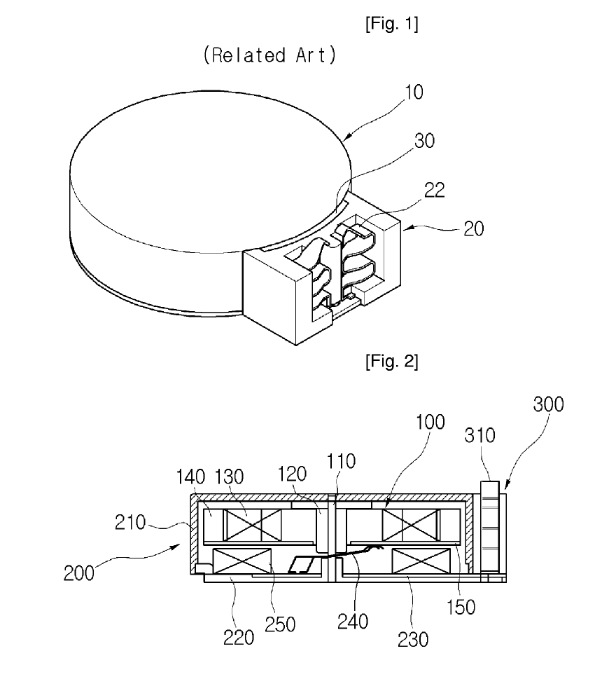

### BEST MODE FOR CARRYING OUT THE INVENTION

Hereinafter, preferred embodiments of a flat vibration motor according to the present invention will be described in detail with reference to the accompanying drawings.

FIG. 2 is a schematic sectional side view showing the interior configuration of a flat vibration motor according to an embodiment of the present invention.

Referring to FIG. 2, a flat vibration motor according to one embodiment of the present invention includes a rotor portion 100, a stator portion 200, and a base portion 300. The rotor portion 100 has a coil 130, a vertical part 140, and a first circuit board 150. The stator portion 200 has an upper case 210, a lower case 220, a second circuit board 230, a brush 240, and a permanent magnet 250. The base portion 300 has a terminal 310.

The shaft 110 is fixed to the lower case 220 and provides a central axis around which the rotor 100 rotates. A bearing 120 is interposed between the shaft 110 and the rotor 100.

The first circuit board 150 is electrically connected to the coil 130, contacting the brush 240 through a commutator (not shown) to transmit electricity to the coil 130.

In this structure, the rotor portion 100, with an eccentric load, rotates within the stator portion 200 to generate vibrating force. To create the eccentric load, the rotor 100 may include an unbalancing member or may be formed to revolve asymmetrically around the rotational axis.

The second circuit board 230 is electrically connected to the terminal 310 on the base 300 and the brush 240.

The permanent magnet 250 is donut-shaped and is disposed on the lower case 220 to generate magnetic repulsion with the coil 130.

The base portion 300 includes the terminal 310 and supplies electricity to the flat vibration motor according to embodiments of the present invention.

### First Embodiment

A description of the coupling structure of the base portion 300 and the stator portion 200 according to the first embodiment of the present invention will now be given, with reference to the diagrams.

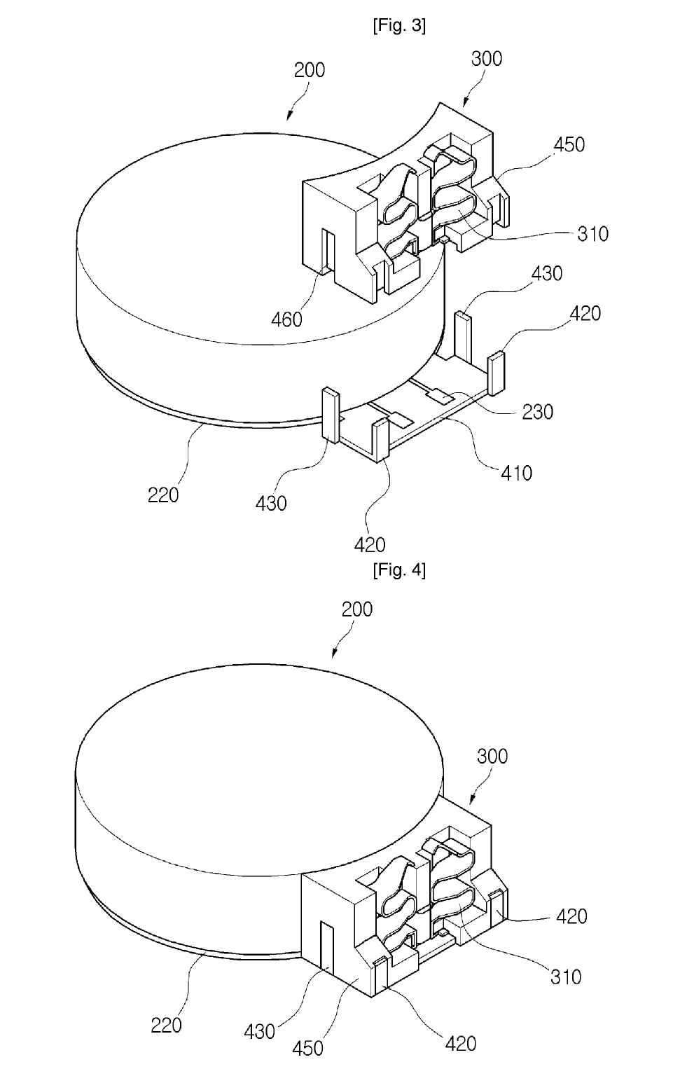

FIG. 3 is perspective view showing a coupling structure of a base portion and a stator portion of a flat vibration motor according to the first embodiment of the present invention, and FIG. 4 is a perspective view showing the base portion assembled with the stator portion of the flat vibration motor in FIG. 3.

Referring to FIGS. 3 and 4, the stator portion 200 has a fixing mount 410 with a plurality of fixing arms 420 and 430 formed thereon. The base portion 300 has a fixing ledge 450 and a fixing groove 460 formed thereon. The fixing mount 410 extends from a side of the lower case 220 to support the bottom of the base portion 300, and the fixing arms 420 and 430 are formed on the edges on either side of the fixing mount 410.

In the flat vibration motor according to the first embodiment of the present invention, there are four fixing arms 420 and 430; however, their number is not limited thereto and may vary according to requirements.

Of the fixing arms, a first fixing arm 420 is formed vertically from the edge of the fixing mount 410 opposite to the stator portion 200.

The second fixing arm 430 is formed vertically from either side edge of the fixing mount 410 that is perpendicular to the direction in which the base portion 300 is supported by the first fixing arm 420.

Here, as shown in FIG. 3, the first fixing arm 420 and the second fixing arm 430 may be formed at different heights.

The heights of the fixing groove 460 may be formed to correspond in height to the first fixing arm 420 and the second fixing arm 430.

As described below, the base portion 300 and the stator portion 200 are coupled, and the terminal 310 is electrically connected with the second circuit board 230.

As shown in FIG. 4, the second fixing arm 430 is inserted into the fixing groove 460 to prevent the base portion 300 from slipping to either side, and the first fixing arm 420 is inserted into the fixing groove of the fixing ledge 450 to mechanically stator portion 200 with the base portion 300.

Also, in the flat vibration motor according to the first embodiment, the fixing arms 420 and 430 may be chemically coupled to the base portion 300 by means of an adhesive (not shown) applied to the coupling surface of the fixing groove 460.

Additionally, the fixing ledge 450, the fixing groove 460, the first fixing arm 420, and the second fixing arm 430 may be formed in a greater number than shown.

Furthermore, an adhesive (not shown) may be applied to the coupling surfaces of the base portion 300 and the stator portion 200. Through this adhesive, the base portion 300 can be more firmly coupled with the stator portion 200.

The coupling surfaces of the base portion 300 and the stator portion 200 may also be chemically, as well as mechanically, coupled by having an adhesive (not shown) applied thereto, to prevent disruptions in the electrical connection of the terminal 310 to the second circuit board 230.

### Second Embodiment

Below, a description of a coupling structure of the base portion 300 and the stator portion 200 of a flat vibration motor according to the second embodiment of the present invention will be given, with reference to the diagrams.

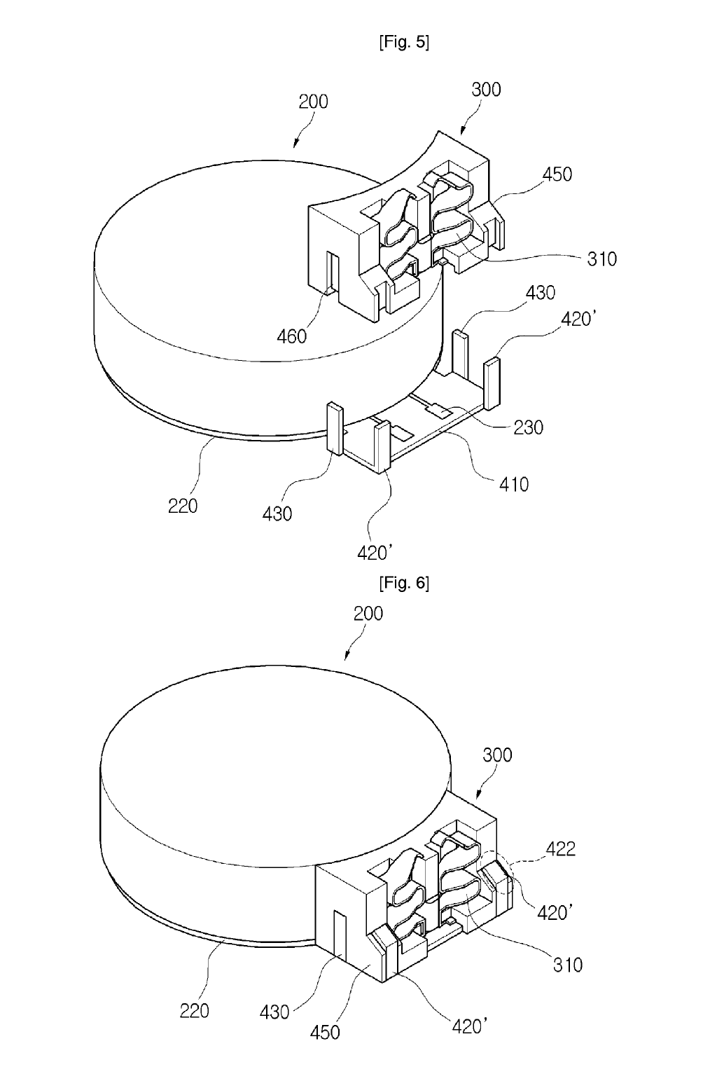

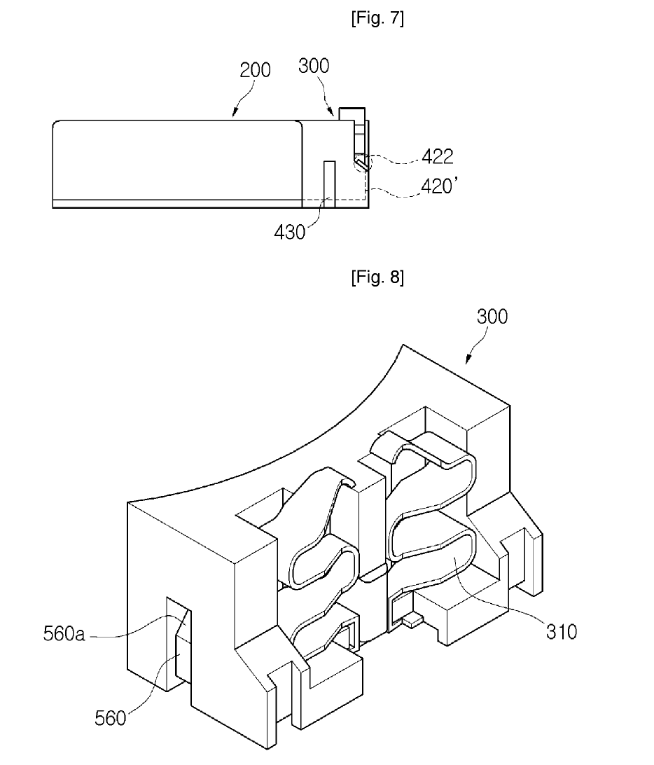

FIG. 5 is a perspective view showing a coupling structure of a base portion 300 and a stator portion 200 of a flat vibration motor according to the second embodiment of the present invention, FIG. 6 is a perspective view showing the base portion 300 assembled with the stator portion 200 of the flat vibration motor in FIG. 5, and FIG. 7 is a side view showing the base portion 300 assembled with the stator potion 200 of the flat vibration motor in FIG. 5.

Referring to FIGS. 5 through 7, the stator portion 200 has a fixing mount 410 with a plurality of fixing arms 420′ and 430 formed thereon. The base portion 300 has a fixing ledge 450 and a fixing groove 460 formed thereon. The fixing mount 410 is formed to extend from a side of the lower case 220 to support the bottom of the base portion 300, and has the fixing arms 420′ and 430 formed on the edges on either side of the fixing mount 410.

Four fixing arms 420′ and 430 are provided in the second embodiment; but these are not limited to four, and may be provided in a greater number depending on requirements.

The following is an explanation of the fixing arms 420′ and 430.

Two first fixing arms 420′ are formed vertically from either side of the edge of the fixing mount 410 opposite to the stator portion 200. The two first fixing arms 420′ have end portions 422 (shown in FIG. 6) that are bent to engage with the two fixing ledges 450, in order to press the base portion 300 towards the stator portion 200 and prevent the base portion 300 from dislodging upward at the same time.

For this purpose, the first fixing arm 420′ may be formed of a metal material capable of plastic deformation, to be bent after the base portion 300 is seated on the fixing mount 410.

Two second fixing arms 430 are formed vertically from either side edge of the fixing mount 410 perpendicular to the direction in which the base portion 300 is supported by the first fixing arm 420′. In the second embodiment, unlike the first fixing arm 420′, the second fixing arm 430 does not need to be changed in shape.

As shown in FIGS. 6 and 7, the second fixing arm 430 is inserted into the fixing groove 460 to prevent the base portion 300 from slipping from either side.

Also, as described above, the fixing ledge 450, the fixing groove 460, the first fixing arm 420′, and the second fixing arm 430 may be formed in a greater number than shown.

Additionally, in the flat vibration motor according to the second embodiment, an adhesive (not shown) may be applied to the coupling surfaces of the base portion 300 and the stator portion 200, in order to provide a firmer coupling between the base portion 300 and the stator portion 200.

Therefore, not only are the base portion 300 and the stator portion 200 coupled mechanically, but they are also coupled chemically, so as to prevent disruptions in the electrical connection between the terminal 310 and the second circuit board 230.

### Third Embodiment

An explanation of a flat vibration motor according to the third embodiment of the present invention will be given below with reference to the diagrams.

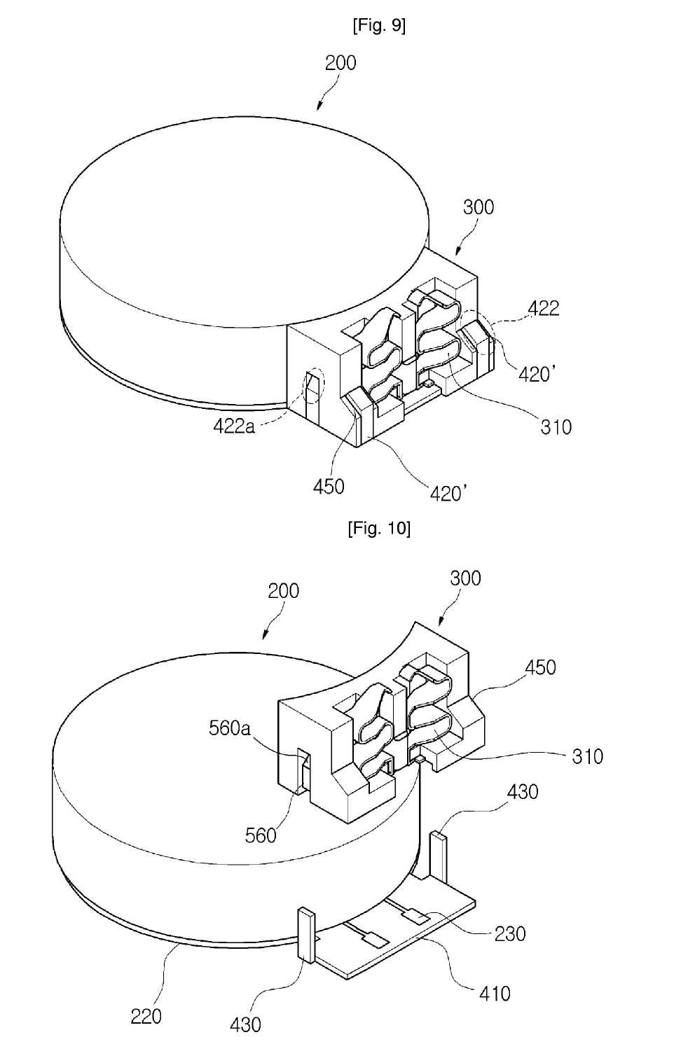

FIG. 8 is a perspective view of a base portion 300 of a flat vibration motor according to the third embodiment of the present invention, and FIG. 9 is a perspective view showing a base portion 300 coupled with a stator portion 200 of a flat vibration motor according to the third embodiment of the present invention.

Referring to FIG. 8, a fixing shelf 560a is formed slanting inward in the fixing groove 560. Accordingly, as shown in FIG. 9, the second fixing arm 430 is inserted in the fixing groove 560, and then its end part 422a bends to angle and engages over the fixing shelf 560a.

The first fixing arm 420′ and the second fixing ledge 450 of the third embodiment may be coupled using the same structure as those of the second embodiment.

If the vibrating force from the flat vibration motor is excessive or the device is used in an environment that incurs severe shocks, the above-described structure of the third embodiment has all four of the fixing arms formed in a bent shape, so that the stator portion 200 and the base portion 300 can more reliably maintain a coupled state.

The number of fixing arms and their opposing shelves/ledges may be increased correspondingly.

In the flat vibration motor according to embodiments of the present invention, the fixing groove 460 has a first fixing groove (not shown) formed on a surface of the base portion 300 and a second fixing groove (not shown) formed on an alternate surface of the base portion 300, so that the fixing groove 460 can support force exerted in at least two directions.

The fixing groove 460 has an angled surface, and the fixing arms 420′ and 430 that insert into the fixing groove 460 are bent to press against the angled surface, so that force in at least three directions can be supported.

Also, the coupling surfaces of the base portion 300 and the stator portion 300 has an adhesive (not shown) applied thereon. This adhesive more firmly couples the base portion 300 with the stator portion 200.

Thus, the base portion 300 and the stator portion 200 are coupled not only mechanically, but also chemically, so that there is no disruption in the electrical connection between the terminal 310 and the second circuit board 230.

### Fourth Embodiment

Below, an explanation of the flat vibration motor according to the fourth embodiment of the present invention will be given, with reference to the diagrams.

FIG. 10 is perspective view showing a coupling structure of the base portion 300 and the stator portion 200 of the flat vibration motor according to the fourth embodiment of the present invention.

In a flat vibration motor according to the fourth embodiment of the present invention, the fixing mount 410 is rectangular in shape, and the fixing arm 430 may be formed vertically from the edge of the fixing mount 410 and the fixing groove 560 may be formed on the base portion 300 to couple with the fixing arm 430.

The fixing groove 560 is formed on either side of the base portion 300, and the fixing arm 430 is formed vertically from either side of the rectangular fixing mount 410 from edges proximal to the stator portion 200 to couple with the fixing grooves 560.

In the fourth embodiment, as described below, the fixing groove 560 forms a fixing shelf 560a angled inward, so that the coupling force of the base portion 300 and the stator portion 200 increases.

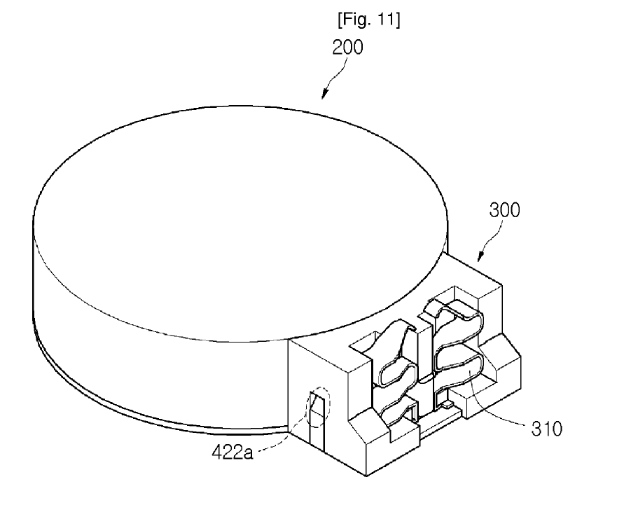

FIG. 11 is a perspective view showing the base portion 300 coupled with the stator portion 200 of the flat vibration motor in FIG. 10.

Referring to FIG. 11, after the fixing arm 430 is inserted into the fixing groove 560, its end part 422a is bent inward to engage with the fixing shelf 560a.

In the flat vibration motor according to the fourth embodiment of the present invention, if the vibrating force from the flat vibration motor is excessive or the device is used in an environment that incurs severe shocks, the fixing arms 430 can be bent to engage with the fixing shelf 560a, to increase coupling strength so that the stator portion 200 and the base portion 300 can more reliably maintain a coupled state.

Also, an adhesive may be applied to the coupling surfaces of the base portion 300 and the stator portion 200, to more firmly couple the base portion 300 with the stator portion 200.

Thus, the base portion 300 and the stator portion 200 are coupled not only mechanically chemically, so that there is not disruption in the electrical connection between the terminal 310 and the second circuit board 230.

### INDUSTRIAL APPLICABILITY

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A flat vibration motor comprising:
a rotor portion for generating vibrating force when rotating;
a stator portion housing and coupled with the rotor portion to allow the rotor portion to rotate, wherein the stator portion transmits electricity to the rotor portion;
a fixing mount extending from a side of a lower case of the stator portion and including fixing arms formed to extend upward therefrom; and
a base portion including a terminal for supplying electricity to the stator portion and fixing grooves formed thereon for respectively coupling with the fixing arms.

2. The flat vibration motor according to claim 1, wherein the fixing mount is roughly rectangular and the fixing arms are formed on at least two edges of the fixing mount, and
wherein the fixing grooves are formed on an outer surface of the base portion to couple with the fixing arms.

3. The flat vibration motor according to claim 1, wherein the fixing arms are formed on either side of the fixing mount, and the fixing grooves are formed on either side surface of the base portion to couple with the fixing arms.

4. The flat vibration motor according to claim 1, wherein at least two fixing arms are formed on one side of the fixing mount, and at least two fixing grooves are formed on one side surface of the base portion to couple with the at least two fixing arms.

5. The flat vibration motor according to claim 1, wherein the fixing grooves are respectively formed on either side of the base portion and a side opposite of the base portion coupling side that contacts with the stator portion, and
wherein the fixing mount is roughly rectangular and the fixing arms are extended from edges of the fixing mount to respectively couple with the fixing grooves.

6. The flat vibration motor according to claim 1, wherein the fixing arms are formed vertically on the fixing mount.

7. The flat vibration motor according to claim 1, wherein an adhesive is applied to an area where the base portion adheres to the stator portion.

8. The flat vibration motor according to claim 1, wherein an adhesive is applied to an area where the fixing arm adheres to the fixing groove.

9. A flat vibration motor comprising:
a rotor portion for generating vibrating force when rotating;
a stator portion housing and coupled with the rotor portion to allow the rotor portion to rotate, wherein the stator portion transmits electricity to the rotor portion;
a fixing mount extending from a side of a lower case of the stator portion and including fixing arms formed to extend upward therefrom; and
a base portion including a terminal for supplying electricity to the stator portion and fixing grooves formed thereon for respectively coupling with the fixing arms,
wherein at least one of the fixing grooves has an angled surface, and the fixing arm coupled with the fixing groove having the angled surface is altered in shape to press against the angled surface, so that the stator portion couples with the base portion.

10. The flat vibration motor according to claim 9, wherein the fixing mount is roughly rectangular and the fixing arms are formed on at least two edges of the fixing mount, and
wherein the fixing grooves are formed on an outer surface of the base portion to couple with the fixing arms.

11. The flat vibration motor according to claim 9, wherein the fixing arms are formed on either side of the fixing mount, and the fixing grooves are formed on either side surface of the base portion to couple with the fixing arms.

12. The flat vibration motor according to claim 9, wherein at least two fixing arms are formed on one side of the fixing mount, and at least two fixing grooves are formed on one side surface of the base portion to couple with the at least two fixing arms.

13. The flat vibration motor according to claim 9, wherein the fixing grooves are respectively formed on either side of the base portion and a side opposite the base portion coupling side that contacts with the stator portion, and
wherein the fixing mount is roughly rectangular and the fixing arms are extended from edges of the fixing mount to respectively couple with the fixing grooves.

14. The flat vibration motor according to claim 9, wherein some of the fixing arms support both side surfaces of the base portion, and others of the fixing arms support an exposed rear surface of the base portion.

15. The flat vibration motor according to claim 9, wherein the fixing arms are formed vertically on the fixing mount.

16. The flat vibration motor according to claim 9, wherein the fixing arms are formed of a plastic deforming metal.

17. The flat vibration motor according to claim 9, wherein an adhesive is applied to an area where the base portion adheres to the stator portion.

18. A flat vibration motor comprising:
a rotor portion for generating vibrating force when rotating;
a stator portion housing and coupled with the rotor portion to allow the rotor portion to rotate, wherein the stator portion transmits electricity to the rotor portion;
a fixing mount extending from a side of a lower case of the stator portion and including fixing arms formed to extend upward therefrom; and
a base portion including a terminal for supplying electricity to the stator portion and fixing grooves formed thereon for respectively coupling with the fixing arms,
wherein the fixing arms support the base portion in at least two directions.

19. The flat vibration motor according to claim 18, wherein at least one of the fixing grooves has an angled surface formed therein, and at least one of the fixing arms is altered in shape to press against the angled surface, for supporting the base portion in at least three different directions.

20. The flat vibration motor according to claim 18, wherein the fixing grooves are respectively formed on either side surface of the base portion and on an exposed rear surface of the base portion, and at least one of the fixing grooves has an angled surface formed therein, and wherein the fixing arm inserted in the fixing groove having the angled surface is altered in shape to press against the angled surface, so that the base portion is supported in at least four directions.
